(19) United States
(12) Patent Application Publication
(10) Pub. No.: US 2010/0148487 A1
(43) Pub. Date: Jun. 17, 2010

(54) FLEXIBLE ADHESIVE LABEL FOR SECURITY FURNISHED WITH AT LEAST ONE CONTACTLESS MICROCIRCUIT FOR AN OFFICIAL DOCUMENT

(75) Inventors: Francois Trantoul, Lunel (FR); Jean-Yves Leroy, Restinclieres (FR)

Correspondence Address: YOUNG & THOMPSON, 209 Madison Street, Suite 500, Alexandria, VA, 22314, US

(73) Assignee: FASVER, BAILLARGUES (FR)

(21) Appl. No.: 12/601,106

(22) PCT Filed: May 20, 2008
(86) PCT No.: PCT/FR2008/000697

§ 371 Date: Nov. 20, 2009

(30) Foreign Application Priority Data
May 21, 2007 (FR) 0703585

(51) Int. Cl. B42D 15/00; G08B 13/14

(52) U.S. Cl. 283/85; 340/572.8

(57) ABSTRACT

A flexible adhesive label for anti-falsification security includes a first flexible sheet (1) whose format corresponds at least substantially to that of the label, at least one antenna (2) for remote transmission and at least one microcircuit (8) all fixed to a first face (14) of the first sheet (1), a layer (15) of external adhesive covering the second face (18) of the first sheet (1), and suitable for allowing the adhesive label to be bonded to an official document. The first sheet (1) and each microcircuit (8) are covered with a second printable flexible sheet (12)—notably of paper—bonded by a layer of adhesive (13) onto the first face (14) and onto each microcircuit (8). The invention extends to an official document including at least one label according to the invention.

The invention relates to a flexible adhesive vignette for anti-falsification security that is intended to be applied onto an imprintable flexible sheet—notably made of paper—of an official document such as a passport or some other official document. It extends to an official document including at least one such vignette.

An adhesive vignette for anti-falsification security makes it possible to link to an object at least one microcircuit connected to at least one antenna for contactless remote transmission of information and/or signals and/or energy capable of being supplied and/or received by this microcircuit, in such a manner as to protect said official document from attempts at falsification and/or to guarantee its authenticity and/or to guarantee the authenticity of inscriptions borne by this official document and/or to guarantee the integrity of such inscriptions.

An official document may be, for example, a passport, a visa, an identity card, a driving license, a label, a legal deed, a contract, a cadastral plan, a manufacturing plan or some other plan, etc., including at least one imprintable flexible sheet—notably made of paper—and incorporating information—notably bearing inscriptions to be read, such as variable markings (surnames, first names, address, photographs etc. of a holder or of parties to a contract etc.) and/or common markings (security motifs, matrices, frames, field names, seals, holograms etc.) to be protected against attempts at falsification and/or for the purposes of authentication and/or in order to guarantee their integrity (i.e. the fact that they have not been altered or modified).

Throughout the text, the expression “inscription to be read” designates any sign or motif realised on a face of an object—notably of a document—that is capable of being read by a man at least under certain conditions (notably under normal illumination in visible light; and/or under specific illumination; and/or after activation of an electronic device (screen) or some other device etc.). It may, for example, be a question, in particular, of texts (handwriting or printed characters); codes (ASCII, universal code for optoelectronic readings, such as bar codes etc.); images or photographs etc.; or other information that is also capable of being at least partly represented by recordable digital data. The term “antenna” designates, in a general way, any electrically conductive line making it possible to realise an electromagnetic—notably inductive and/or magnetic—coupling with another electromagnetic device. The term “vignette” designates any article exhibiting the general shape of a sheet of a size smaller than the A4 size. A vignette may form a ticket, an adhesive label, a protective film, an insert intended to be placed between two layers or sheets etc. The term “microcircuit” designates any device of a size smaller than 5 mm×5 mm×1 mm forming an electronic circuit that is realised essentially in accordance with the technologies of integrated circuits. It may be a question, in particular, of a memory chip (ROM, RAM, EPPROM, flash etc.) and/or microprocessor chip and/or hard-wired logic chip, endowed or not endowed with other non-electronic or accessory functions (antenna) or with several chips which are linked in order to form such a device.

Various devices and processes are already known that enable at least one microcircuit to be linked to an official document, in particular with at least one antenna for contactless remote transmission.

FR 2 886 038 describes a flexible adhesive vignette for anti-falsification security, including:
a first flexible sheet, the size of which corresponds at least substantially to that of the vignette,
at least one antenna for remote transmission of information and/or signals and/or energy capable of being supplied and/or received by a microcircuit, this transmission antenna exhibiting electrical-connection terminals linked to a first face of said first sheet,
at least one microcircuit fixed to said first face of the first sheet in such a manner as to be in electrical contact with electrical-connection terminals of a corresponding transmission antenna,
a layer of external adhesive covering the second face, opposite the first face, of said first sheet, in order to enable the gluing of the adhesive vignette onto a face of an object such as a sheet of an official document.

In one embodiment described in this document, the vignette includes two layers of external adhesive, of which one layer of external adhesive covers the second face, opposite the first face, of said first sheet. This bifacial adhesive vignette can be glued between two sheets of a notebook. In the other embodiments described in this document, the vignette includes a single layer of external adhesive which covers the microcircuit and various layers of varnish for thickness compensation, these latter layers being realised, starting from said first face of the first sheet, by exhibiting a compartment for reception of the microcircuit.

However, in practice it turns out that the manufacture of such a vignette is relatively complex and costly.

In addition, the use of such a vignette, for example in an official travel document such as a passport, presupposes in general that the vignette is integrated into the cover of the passport or inserted between two sheets pasted onto one another. In this latter case a relatively rigid leaf of significant thickness results, which impairs the general quality of the official document and makes it possible to detect the presence of the microcircuit.

Furthermore, this known vignette cannot be used in economic manner in order to modify already manufactured passports by endowing them with at least one microcircuit. It is to be noted that, in general, printers of official documents such as travel documents, in particular passports, manufacture these documents in relatively significant stocks. It is not uncommon for a State to have several years' stock of passports at its disposal. Moreover, in each State there often exist various kinds of passports: ordinary passports, service passports, diplomatic passports, emergency passports etc. These various passports do not all need to have the same level of security. Some have to be equipped with a microcircuit, but others do not.

FR 2 868 987 also describes a structure including an electronic device, an at least partly fibrous inserted layer with a window in which the electronic device extends at least partly, and a layer of adhesive in contact with the inserted layer. Such a structure which provides for a fibrous inserted layer—that is to say, notably made of paper—for thickness compensation for the electronic device is not very flexible, modifies the flexibility of the document on which it is possibly affixed, and poorly resists attempts at falsification by delamination, since the thick inserted layer (of the order of at least 200 μm) facilitates the delamination operations. Within this context, the invention aims to propose a flexible adhesive vignette for anti-falsification security incorporating at least one microcircuit and intended to be applied onto an imprintable flexible sheet—notably made of paper—of an official document such as a passport or some other official document, exhibiting great resistance to attempts at falsification and having manufacturing costs that are reduced.

More particularly, the invention aims to propose such a vignette that makes it possible to facilitate the modification of previously manufactured official documents for the insertion of microcircuits at lower cost, whatever the technology used for the realisation of these official documents and/or whatever the nature and the purpose of these official documents. In this sense, the invention therefore aims to facilitate the manufacture of the official documents and to reduce the manufacturing costs thereof.

The invention also aims to propose such a vignette that is, more particularly, suitable to enable the insertion in invisible manner of at least one microcircuit into an official physical document, the vignette appearing as a normal printing substrate of the official document.

In order to do this, the invention relates to a flexible adhesive vignette for anti-falsification security, including:
a first flexible sheet, the size of which corresponds at least substantially to that of the vignette,
at least one antenna for remote transmission of information and/or signals and/or energy capable of being supplied and/or received by a microcircuit, this transmission antenna exhibiting electrical-connection terminals linked to a first face of said first sheet,
at least one microcircuit fixed to said first face of the first sheet in such a manner as to be in electrical contact with electrical-connection terminals of a corresponding transmission antenna,
a layer of external adhesive covering the second face, opposite the first face, of said first sheet, this layer of external adhesive being suitable to enable the gluing of the adhesive vignette onto a face of an imprintable flexible sheet of an official document,
   wherein said first sheet and each microcircuit are covered with a second imprintable flexible sheet—notably made of paper—pasted by means of a layer of adhesive onto said first face of said first sheet and onto each microcircuit, said layer of adhesive adhering simultaneously to the transmission antenna and to each microcircuit and serving as thickness compensation for each microcircuit.

In this way the invention makes it possible to obtain, at lower cost, a vignette that is capable of serving itself as printing substrate after being affixed to a sheet of an official document, this vignette including at least one perfectly protected, invisible microcircuit embedded in the thickness of the vignette, which retains its functionalities in the course of the various manipulations of the official document, the flexibility of this latter not being substantially affected by the vignette, notably by the microcircuit. A vignette according to the invention is in fact flexible—that is to say, in particular neither rigid nor semi-rigid. Its flexibility preferably corresponds at least substantially to that of the sheet of the official document on which it is intended to be applied. It generates only a slight extra thickness.

From the point of view of the cost of manufacture, it is to be noted that in a vignette according to the invention the fitting of a microcircuit is particularly simple and economical, and that the number of layers constituting the vignette can be reduced to a minimum. In particular, the layer of adhesive making it possible to fix the second flexible sheet onto the first flexible sheet can serve as thickness compensation for each microcircuit, by encasing this latter and by protecting it. Such an assembly also confers great resistance to attempts at falsification; insofar as this layer of adhesive adheres simultaneously to the printed transmission antenna and to each microcircuit, any attempt at delamination of a vignette according to the invention has the consequence that the operation of the microcircuit is altered definitively.

In particular, advantageously and according to the invention, the transmission antenna is constituted by at least one whorl of conductive ink printed on said first face of said first sheet, and said connection terminals are also constituted by a conductive ink printed on said first face of said first sheet. In this way, in a particularly advantageous embodiment of the invention the transmission antenna is simply printed on said first face of said first sheet.

Furthermore, advantageously and according to the invention, each microcircuit is fixed to said first face of said first sheet by gluing, for example with the aid of a glue that is not electrically conductive. This microcircuit exhibits connection terminals which then come directly into contact with the connection terminals of the previously printed antenna. In other words, the microcircuit is fixed to said first face of the first sheet by an assembly of the type known as “flip-chip”. Such an assembly is particularly simple and economical.

Advantageously, a vignette according to the invention includes at least one layer for peripheral reinforcement extending around at least one microcircuit fixed to said first face according to a size smaller than that of said first sheet, the whole formed by each layer for peripheral reinforcement forming, starting from said first face of said first sheet, a total thickness greater than or equal to that of the microcircuit, starting from said first face of said first sheet.

The whole formed by each layer for peripheral reinforcement preferably exhibits a flexural rigidity greater than that of said first sheet.

According to one embodiment of the invention, the vignette includes, by way of layer(s) for peripheral reinforcement, at least one peripheral-reinforcement strip of varnish printed in at least one layer around the microcircuit.

In another advantageous embodiment, a vignette according to the invention includes, by way of layer(s) for peripheral reinforcement, a peripheral-reinforcement disc adhering to said first face around a microcircuit, said disc exhibiting a recess accommodating the microcircuit and having a size smaller than that of said first sheet. In addition, advantageously and according to the invention, said disc is constituted by a part glued to said first face of said first sheet.

Advantageously and according to the invention, said disc is constituted by a material chosen from the group comprising polyesters, polymethacrylates, polycarbonates, polystyrenes, polyethylenes, polypropylenes and polyamides. More particularly, preferably and according to the invention, this material is chosen from the group constituted by polyesters, polycarbonates and polypropylenes. In particular, this disc is not constituted by a polyvinyl chloride, such a material being either too flexible or too rigid and not retaining its properties over time. Good results have been obtained with a disc produced from polyester.

The whole formed by each layer for peripheral reinforcement, and in particular said disc, may exhibit any shape appropriate for the envisaged application of the vignette in the invention. Advantageously, the whole formed by each layer for peripheral reinforcement is in the general shape of a disc or polygonal and/or exhibits a broken or corrugated contour or some other contour. Similarly, the general dimensions of this whole—notably of this disc—are variable, according to the envisaged application of the vignette according to the invention. In an advantageous embodiment, the whole formed by each layer for peripheral reinforcement—notably said disc—exhibits an overall width ranging between 10 mm and 30 mm—notably of the order of 20 mm to 25 mm.

In addition, advantageously and according to the invention, the whole formed by each layer for peripheral reinforcement—notably said disc—exhibits a total thickness ranging between 100 μm and 250 μm—notably of the order of 180 μm.

Furthermore, in a preferential embodiment and according to the invention, said second sheet is constituted by a security paper having a density of at least 90 g/m². A security paper is a paper that is suitable to resist attempts at falsification, for example a paper that is free from optical brightener and/or with weak internal cohesion and/or containing watermarks and/or security threads and/or security fibres and/or chemically reactive agents etc. In addition, advantageously and according to the invention, said second sheet bears imprints of anti-falsification security motifs on its free outer face.

Furthermore, advantageously and according to the invention, the first sheet and the second sheet are of similar size corresponding approximately to that of a sheet of an official document on which said vignette is intended to be affixed. For example, notably in the case of a vignette that is intended to be inserted into a passport, the first sheet and the second sheet are of a size smaller than A4—notably with a size of the order of 88 mm×125 mm—or slightly larger than this size (in order to be capable of being cut exactly to this size afterwards) or smaller than this size.

The invention also extends to an official document—notably a passport, a driving license, a vehicle registration certificate, a diploma, an administrative certificate and/or identification certificate and/or an authentication certificate, a contract—which is characterised in that it includes at least one vignette according to the invention which is applied on a face of an imprintable flexible sheet—notably made of paper—of this official document. The invention relates, more particularly, to such an official document taking the form of a notebook, for example a passport.

The invention also relates to a vignette and to an official document, which are characterised in combination by all or some of the characteristics mentioned above or below.

Other objectives, characteristics and advantages of the invention will become apparent from the following description which refers to the annexed Figures which represent, by way of non-limiting example, an embodiment of the invention, and in which:

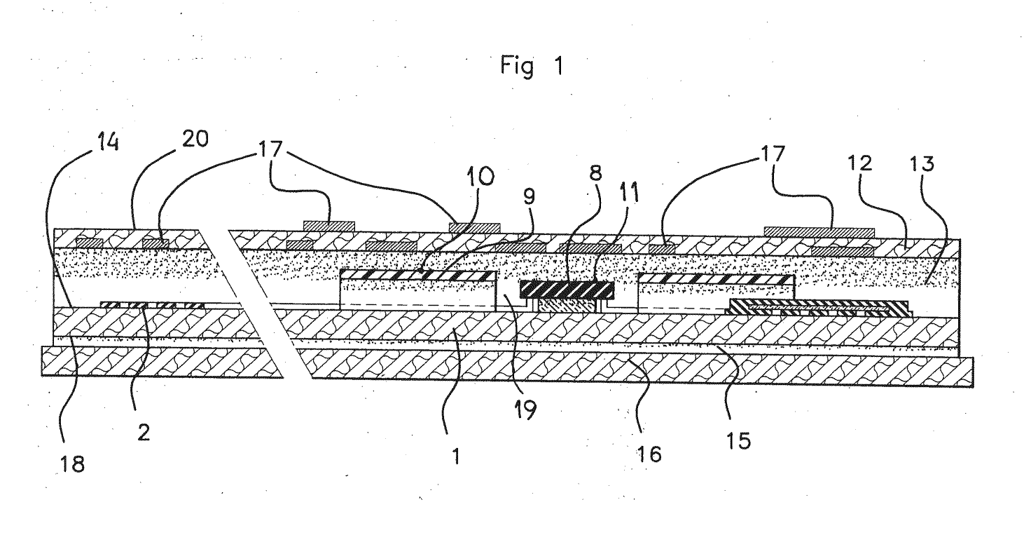

FIG. 1 is a diagram in cross-section of a vignette according to the invention,

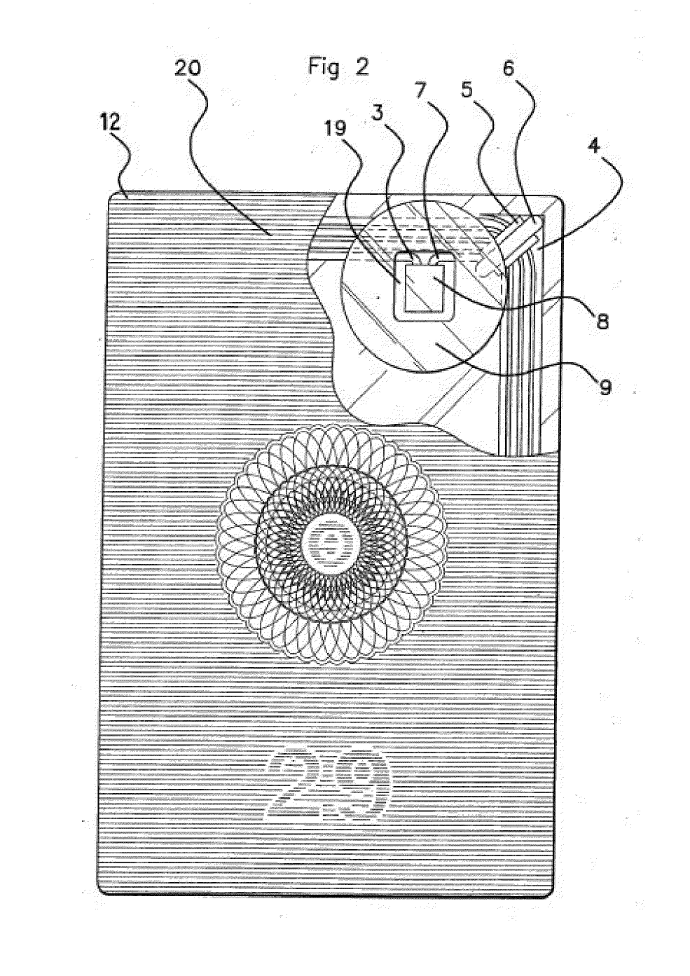

FIG. 2 is a schematic view from above of the vignette shown in FIG. 1, with a partial tear showing the microcircuit,

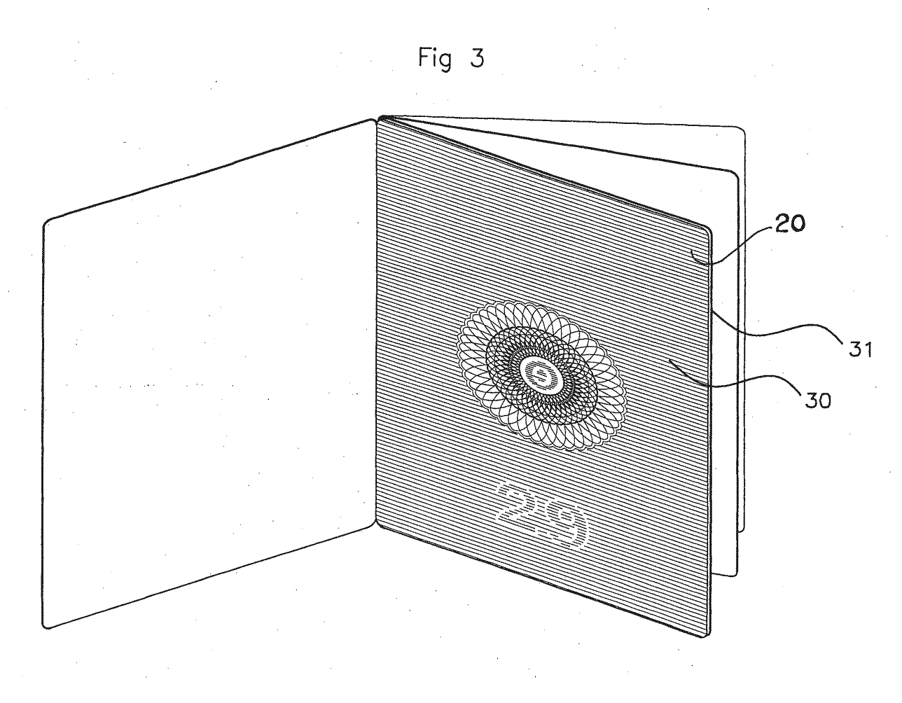

FIG. 3 is a diagram in perspective of an official document according to the invention in the form of a notebook, one page of which receives a vignette according to the invention.

In the Figures the thicknesses are exaggerated and the scales of thickness are not observed, for purposes of illustration.

The vignette according to the invention that is represented in FIGS. 1 and 2 includes, first of all, a first flexible sheet 1 defining the overall size of the vignette, smaller than the A4 size and suitable for the envisaged use of the vignette. This first flexible sheet 1 is suitable to be able to form a printing substrate and to be able to receive a microcircuit 8 and a second adhesive flexible sheet 12, 13 as described below. In the example that is represented, the first flexible sheet 1 may be constituted by a sheet of paper, for example weighing 90 g/m², or of polyester or some other flexible synthetic material, of a size corresponding to that of a passport sheet, for example of the order of 88 mm×125 mm.

On a first face 14 of this first flexible sheet 1 there are printed with a conductive ink a plurality of concentric whorls forming an antenna 2 for contactless remote transmission. The characteristics and dimensions of this transmission antenna 2 are adapted according to the envisaged application, in particular according to the operating frequency, the nature of the information and/or of the signals and/or of the energy to be exchanged by means of this transmission antenna 2, the range that the transmission antenna has to exhibit etc. Advantageously, the transmission antenna 2 is produced in such a manner as to exhibit a tuning frequency of the order of 13.56 MHz. This frequency corresponds, in particular, to standards ISO 15693, ISO 14443 A and ISO 14443 B. In order to obtain this frequency, the width and the thickness of the strip of conductive ink forming the transmission antenna 2, as well as the dimension of the whorls and the distance between the whorls, are adjusted in a manner well known in itself. This conductive ink may be printed in accordance with any known process, for example by silk-screen printing in one or more successive steps. For example, in order to print this transmission antenna 2, use is made of a composition of solvent-based conductive ink, catalogue number 5029, marketed by the company du Pont de Nemours (Bristol, Great Britain), printed by silk-screen printing. In the example that is represented, the whorls are of rectangular shape overall, extending close to the peripheral border of the first flexible sheet 1. There is nothing to prevent the provision of an antenna 2 constituted by whorls of another shape, for example circular or other.

The whorls forming the transmission antenna 2 exhibit a first, inner end 3 and a second, outer end 4, these two ends 3, 4 being in the vicinity of one another. A strip of electrically insulating varnish 5 covers the whorls in the vicinity of the outer end 4, and this strip of insulating varnish 5 is covered with a connecting strip 6 of electrically conductive ink which is connected to the outer end 4 and the opposite end 7 of which is in the immediate vicinity of the inner end 3 of the whorls forming the antenna 2, so that these ends 3, 7 which are adjacent to one another constitute connection terminals 3, 7 for a microcircuit 8.

This microcircuit 8 may be fixed by a glue (electrically insulating or conductive) on the first flexible sheet 1 between the two connection terminals 3, 7, according to an assembly of the type known as “flip-chip”, in a manner well known in itself. The microcircuit 8 is, for example, a chip marketed by the company Philips Europe (Graz, Austria) under the brand Smartm×® with a 72 kb microprocessor; or a chip marketed by the company Inside (Aix-en-Provence, France) under the brand Picopass® with a 4 kb memory; or any other microcircuit appropriate for the use of the vignette.

The first flexible sheet 1 is endowed, on its second face 18 opposite that 14 receiving the microcircuit 8, with a layer of adhesive 15 protected by a detachable sheet 16, for example a sheet of silicone-coated paper. This layer of adhesive 15 may be constituted by an adhesive that is sensitive to cold pressure or by an adhesive that is capable of being activated by heat or otherwise. The vignette according to the invention is therefore an adhesive vignette. It may, for example, be glued to a passport page.

In order to reinforce the vignette locally around the microcircuit 8, an adhesive disc 9 for peripheral reinforcement is applied onto the first flexible sheet 1 above the microcircuit 8, covering the underlying portions of the antenna 2.

The disc 9 exhibits a recess 19 accommodating the microcircuit 8 in such a manner as not to create extra thickness above the microcircuit 8. In order to facilitate the manufacture of the disc 9, this recess 19 may be constituted by a simple aperture 19 of a shape corresponding to that of the microcircuit 8 and traversing the thickness of the disc 9 in the central part.

This disc 9 for peripheral reinforcement exhibits a total thickness (including the layer of adhesive enabling it to be made integral with the flexible support 1) slightly greater than that formed by the antenna 2, the microcircuit 8 and the glue that fixes it on the first flexible sheet 1, in such a manner that the free upper face 10 of the disc 9 is situated, in relation to the flexible support 1, at a level slightly higher than the free upper face 11 of the microcircuit 8. Consequently, the disc 9 for peripheral reinforcement realises a thickness compensation around the microcircuit 8. By way of example, the disc 9 exhibits a total thickness ranging between 100 μm and 250 μm, typically of the order of 180 μm.

The size of the disc 9 is smaller than that of the first flexible sheet 1. In fact, the dimension given to the disc 9 is sufficient in order to reinforce the vignette locally around the microcircuit 8, taking into account the mechanical imperatives required for the vignette, but as low as possible in order to preserve the flexibility of the first flexible sheet 1.

In practice, a disc 9 extending laterally around the microcircuit 8 in all directions at a distance ranging between one and three times the width of the microcircuit 8 provides excellent results. In this way, the disc 9 may exhibit an overall total width ranging between 10 mm and 30 mm—notably of the order of 20 mm to 25 mm. The disc 9 may exhibit any appropriate shape and may be, for example, in the general shape of a disc or polygonal or another shape.

The disc 9 for peripheral reinforcement extends in this way over an overall area of less than 10 cm² and less than 25%, preferably less than 10%, of the area of the first flexible sheet 1.

The constituent material of the disc 9 is chosen in accordance with the properties required for this disc 9, namely a good compressive resistance and a flexural rigidity that is sufficient to protect the microcircuit 8 without thereby impairing the flexibility properties required for the vignette. The disc 9 preferably exhibits a flexural rigidity greater than or equal to that of the first flexible sheet 1. This higher rigidity may, first of all, be conferred by a more significant thickness. It may also be the result of the choice of a distinct material. Advantageously and according to the invention, the disc 9 is constituted by a material chosen from the group comprising polyesters, polymethacrylates, polycarbonates, polystyrenes, polyethylenes, polypropylenes and polyamides.

The disc 9 may be constituted by a layer or by a plurality of superposed layers. Each layer may be a portion of film or of cut sheet or a printed layer. By way of example, the disc 9 may be constituted by a polyester sheet with a thickness of 50 μm to 75 μm endowed with a layer of transfer adhesive with a thickness of 50 μm to 125 μm.

The microcircuit 8, the disc 9 and the transmission antenna 2 are furthermore covered with an adhesive sheet 12, 13. This adhesive sheet 12, 13 includes a second imprintable flexible sheet 12, for example constituted by a paper in a single layer or in several layers, by a layer or by a laminated complex of several layers of fibrous material(s), based on cellulose fibres or thermoplastic polymeric materials, woven(s), or non-wovens (fibres agglomerated in a binder). This second flexible sheet 12 is cut according to a size corresponding at least substantially to that of the first flexible sheet 1. The constituent material of the second flexible sheet 12 is chosen so that the outer face 20 of this second sheet 12 may be imprintable—that is to say, it may serve as printing substrate, for example in order to receive common or variable inscriptions, in the manner of a page of an official document. In addition, the constituent material of the second flexible sheet 12 is preferably of a type known as “secured”—that is to say, appropriate to resist attempts at falsification. For example, it is a question of a security paper having a density of at least 90 g/m² and a thickness of the order of 100 μm to 120 μm, for example a security paper, catalogue number CBS1, of density 95 g/m² marketed by the company LANDQART (P.O. box, Switzerland).

This second sheet 12 is glued onto the first flexible sheet 1 with the aid of a layer of adhesive 13, which may be an adhesive that is sensitive to cold pressure or an adhesive that is laid by hot rolling or by other means. The layer of adhesive 13 comes to complement the disc 9 laterally up to the size of the first flexible sheet 1 and over at least a portion of the thickness of this disc 9. In this way, it constitutes a compensation of thickness and of size in relation to the disc 9.

This layer of adhesive 13 preferably exhibits, once laid, a thickness greater than 100 μm, for example of the order of 180 μm, in such a manner as to minimise any visible extra thickness of the disc 9. Advantageously, this adhesive sheet 12, 13, and quite particularly the layer of adhesive 13, is suitable to be locally deformable by compression in order to absorb the extra thickness formed by the disc 9.

The adhesive sheet 12, 13, and more particularly the second sheet 12, preferably exhibits a flexural rigidity lower than that of the disc 9. In addition, its flexural rigidity is also lower than or equal to that of the first flexible sheet 1, in such a manner as not to modify substantially the flexibility in flexion of the vignette according to the invention.

This adhesive sheet 12, 13 makes it possible, on the one hand, to compensate the size of the disc 9, on the other hand to reinforce the vignette according to the invention (yet without substantially modifying its flexibility) and to protect the antenna 2 and the microcircuit 8. This adhesive sheet 12, 13 is applied lastly, covering the antenna 2, the disc 9 and the microcircuit 8.

So it is to be noted that the adhesive sheet 12, 13 covers the microcircuit 8, the layer of adhesive 13 penetrating into the space situated between the central aperture 19 of the disc 9 and the microcircuit 8. In this way the protection of the microcircuit 8 is reinforced.

The disc 9 may be replaced and/or complemented by at least one peripheral-reinforcement strip of varnish printed around the microcircuit 8. Such a peripheral-reinforcement strip of varnish may be printed simultaneously with the insulating strip of varnish 5, with the same varnish. It then exhibits a thickness, starting from the flexible substrate 1, less than that of the microcircuit 8. Nevertheless, the layer of adhesive 13 comes to complement the thickness of said peripheral-reinforcement strip, this layer of adhesive 13 being deformed in order to receive the protruding portion of the microcircuit 8 and to absorb its thickness without creating visible extra thickness.

The vignette according to the invention also includes anti-falsification security motifs 17 and/or authentication motifs and/or motifs that cannot be reproduced by optical reading, or other motifs. These security motifs 17 can be printed on the outer face 20 of the second sheet 12 covering the disc 9 and/or between the second sheet 12 and the layer of adhesive 13 when the second sheet 12 is constituted by an at least partly transparent material. For example, such security motifs 17 are holograms and/or motifs such as described by U.S. Pat. No. 6,336,666 and/or U.S. Pat. No. 6,494,490 and/or U.S. Pat. No. 6,592,972 or FR 2 675 742.

In order to produce such a vignette according to the invention, first of all the transmission antenna 2 is printed on the first face 14 of the first sheet 1, then the connection terminals 3, 7 are produced by printing the insulating strip of varnish 5 and the connecting strip 6, then the microcircuit 8 is fitted by connecting it to the connection terminals 3, 7, then the disc 9 is applied by accommodating the microcircuit 8 in the aperture 19, then the adhesive sheet 12, 13 is laminated in such a manner as to glue the second sheet 12 by means of the adhesive 13 onto the small first face 14 of the first sheet 1. The laying of the layer of adhesive 15 on the second face 18 of the first sheet 1, which is covered with a detachable protective paper 16, is then carried out. All these operations can be carried out in grouped manner and continuously, as for the manufacture of traditional labels, starting from strips initially in the form of reels, which are unreeled in order to carry out the various successive treatments. Afterwards a half-through cutting (kiss-cutting) of each vignette is carried out to the desired size in the thickness of the adhesive sheet 12, 13, of the first sheet 1 and of the adhesive 15, the detachable protective paper 16 that is not cut out finally constituting a continuous substrate that is capable of being wound up into a reel comprising a plurality of vignettes according to the invention. The offcut portions of the first sheet 1 and of the second sheet 12 that are cut out between the vignettes can be removed by peeling or otherwise.

The total thickness of a vignette according to the invention typically ranges between 400 μm and 600 μm.

As represented in FIG. 3, a vignette according to the invention can be applied onto a page of a sheet of an official document such as a passport, with total covering of this page in such a manner as to exhibit an imprintable outer face 20 replacing the initial page of the document.

In this way, in a process of treatment of an official document with the aid of a vignette according to the invention a vignette 30 according to the invention is chosen having the size of a page 31 of this official document, the vignette is glued, with total covering of this page 31, with the aid of the layer of adhesive 15 extending over the second face 18 of the first sheet 1, so that the vignette 30 exhibits an imprintable outer face 20 mimicking said page 31 of the official document treated in this way. The presence of the vignette according to the invention is therefore not easily detectable. The same applies to the microcircuit 8 which it incorporates, embedded in its thickness.

It goes without saying that the invention may be the subject of numerous implementation variants in relation to the preferential embodiment described above and represented in the Figures. In particular, the vignette according to the invention may incorporate other security elements, notably one or more layers of varnish. Each vignette according to the invention preferably includes only a single microcircuit 8 connected to only a single transmission antenna 2. However, there is nothing to prevent the provision of several microcircuits 8 and/or several transmission antennas 2 on one and the same vignette according to the invention.

A vignette according to the invention is particularly advantageously applicable to the realisation of a passport according to the invention. It may nevertheless also be the object of other applications, notably for the realisation and/or protection of other official documents such as identity cards, contracts etc.

1.-17. (canceled)

18. A flexible adhesive vignette for anti-falsification security, including:
a first flexible sheet, the size of which corresponds at least substantially to that of the vignette,
at least one antenna for remote transmission, said transmission antenna exhibiting electrical-connection terminals linked to a first face of said first sheet,
at least one microcircuit fixed to said first face of said first sheet in such a manner as to be in electrical contact with electrical-connection terminals of a corresponding transmission antenna,
a layer of external adhesive covering a second face, opposite said first face, of said first sheet, said layer of external adhesive being chosen to enable the gluing of the adhesive vignette onto a face of an imprintable flexible sheet of an official document,
wherein said first sheet and each microcircuit are covered with a second imprintable flexible sheet pasted by means of a layer of adhesive onto said first face of said first sheet and onto each microcircuit, said layer of adhesive adhering simultaneously to each microcircuit and to said corresponding transmission antenna and forming a thickness compensation for each microcircuit.

19. A vignette as claimed in claim 18, wherein said at least one transmission antenna is constituted by at least one whorl of conductive ink printed on said first face of said first sheet and wherein said connection terminals are also constituted by a conductive ink printed on said first face of said first sheet.

20. A vignette as claimed in claim 18, wherein each microcircuit is fixed to said first face of said first sheet by gluing.

21. A vignette as claimed in claim 18, wherein it includes at least one reinforcing layer for peripheral reinforcement, extending around at least one microcircuit fixed to said first face, said at least one reinforcing layer extending according to a size smaller than that of said first sheet, the whole formed by each reinforcing layer having, starting from said first face of said first sheet, a total thickness greater than or equal to that of said and at least one microcircuit, starting from said first face of said first sheet.

22. A vignette as claimed in claim 21, wherein the whole formed by each reinforcing layer exhibits a flexural rigidity greater than that of said first sheet.

23. A vignette as claimed in claim 21, wherein it includes, as said at least one reinforcing layer, at least one peripheral-reinforcement strip of varnish printed in at least one layer around said at least one microcircuit.

24. A vignette as claimed in claim 21, wherein it includes, as said at least one reinforcing layer, a peripheral reinforcement disc adhering to said first face around a microcircuit, said disc exhibiting a recess accommodating the microcircuit and having a size smaller than that of said first sheet.

25. A vignette as claimed in claim 24, wherein said disc is formed in a material chosen in the group consisting in polyesters, polymethacrylates, polycarbonates, polystyrenes, polyethylenes, polypropylenes and polyamides.

26. A vignette as claimed claim 18, wherein said layer of adhesive enabling the gluing of said second sheet onto the first sheet, exhibits a thickness greater than 100 μm.

27. A vignette as claimed claim 18, wherein said second sheet and said layer of adhesive constitute an adhesive sheet exhibiting a flexural rigidity lower than or equal to that of said first flexible sheet.

28. A vignette as claimed in claim 18, wherein said second sheet is constituted by a security paper having a density of at least 90 g/m2.

29. A vignette as claimed in claim 18, wherein said second sheet bears anti-falsification security printed motifs on its free outer face.

30. A vignette as claimed in claim 18, wherein said first sheet and said second sheet are of similar size corresponding to that of a sheet of an official document on which said vignette is affixed.

31. A vignette as claimed in claim 18, wherein said first sheet and said second sheet are of a size smaller than A4.

32. A vignette as claimed in claim 18, wherein said first sheet and said second sheet are in a size of about 88 mm×125 mm.

33. An official document such as a passport, a driving license, a vehicle registration certificate, a diploma, an administrative certificate, an identification certificate an authentication certificate, or an agreement deed, wherein it includes, applied on a face of an imprintable flexible sheet of this official document, at least one flexible adhesive vignette for anti-falsification security, including:
a first flexible sheet, the size of which corresponds at least substantially to that of the vignette,
at least one antenna for remote transmission, said transmission antenna exhibiting electrical-connection terminals linked to a first face of said first sheet,
at least one microcircuit fixed to said first face of said first sheet in such a manner as to be in electrical contact with electrical-connection terminals of a corresponding transmission antenna,
a layer of external adhesive covering a second face, opposite said first face, of said first sheet, said layer of external adhesive being chosen to enable the gluing of the adhesive vignette onto a face of an imprintable flexible sheet of an official document,
and wherein said first sheet and each microcircuit are covered with a second imprintable flexible sheet pasted by means of a layer of adhesive onto said first face of said first sheet and onto each microcircuit, said layer of adhesive adhering simultaneously to each microcircuit and to said corresponding transmission antenna and forming a thickness compensation for each microcircuit.

34. An official document as claimed in claim 33, wherein it is a notebook.
